(19) United States
(12) Patent Application Publication
(10) Pub. No.: US 2021/0142407 A1
(43) Pub. Date: May 13, 2021

(54) Distributed Markets

(71) Applicant: Volker Gustav-Adolf Rudolph, Munich (DE)

(72) Inventor: Volker Gustav-Adolf Rudolph, Munich (DE)

(21) Appl. No.: 17/089,023

(22) Filed: Nov. 4, 2020

Related U.S. Application Data
(60) Provisional application No. 62/933,188, filed on Nov. 8, 2019.

(51) Int. Cl. G06Q 40/04; G06Q 20/12; G06Q 20/06

(52) U.S. Cl. CPC G06Q 40/04; G06Q 2220/00; G06Q 20/0655; G06Q 20/12

(57) ABSTRACT

A system including a resource chain including a plurality of communicably coupled resource nodes, each resource node operable to communicate a product or a service information, which may be grouped into unique markets. A payment chain, said payment chain including a plurality of communicably coupled payment nodes, each payment node operable to communicate financial information. A demand node, said demand node including an interface operable to receive a transaction request, said transaction request including a product or service, and a processing device to perform a method including: receiving a transaction request; comparing the transaction request to the product or service information; initiating a transaction in response to said comparing, and transferring payment information from a first payment node to a second payment node. Payment may be in different currency units including a transitional currency.

### PRIORITY

This application claims the benefit of U.S. provisional patent application 62/933,188, filed Nov. 8, 2019 entitled “Distributed Markets” which is included by reference as if fully set forth herein.

### SUMMARY

Disclosed herein is a system which may include a resource chain including a plurality of communicably coupled resource nodes, each resource node operable to communicate a product or a service information. These resource nodes may be grouped into unique markets. Also disclosed is a payment chain, said payment chain may include a plurality of communicably coupled payment nodes, each payment node operable to communicate financial information. A demand node is also disclosed, said demand node including an interface operable to receive a transaction request, said transaction request including a product or service. A processing device is disclosed which may perform a method including: receiving a transaction request; comparing the transaction request to the product or service information; initiating a transaction in response to said comparing, and transferring payment information from a first payment node to a second payment node. Payment may be in different currency units including a transitional currency.

In some embodiments a resource chain includes product or service information grouped into unique markets and the payment chain may include nodes with different native currency units including a transitional currency or, in some embodiments, a crypto currency. This disclosure may be employed in various industries such as health care, manufacturing, financial, and the like.

### BRIEF DESCRIPTION OF THE DRAWINGS

FIG. 1 shows a functional block diagram of a client server system

FIG. 2 illustrates an embodiment that may be employed using the techniques described herein.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “declarative language” generally refers to a programming language that allows programming by defining the boundary conditions and constraints and letting the computer determine a solution that meets these requirements. Many languages applying this style attempt to minimize or eliminate side effects by describing what the program should accomplish, rather than describing how to go about accomplishing it. This is in contrast with imperative programming, which requires an explicitly provided algorithm.

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The term “service level agreement” (SLA) generally means an agreement between providers for Internet based computing resources such as servers, databases, and data storage systems and clients. SLAs generally contain details about what services are available, pricing for those services and availability for those resources. SLAs may also include workload, queue size, disk space availability, CPU load, network latency, or business metrics such as cost or location.

The word “stack” or “logical stack” generally refers to a set of software subsystems or components needed to deliver a fully functional solution, e.g. a product or service. Often a stack may include an operating system, a server, a data management system and a scripting or other form of programming language. Stacks may be configured in a variety of ways depending on the desire function of the system. Stacks may be collections of elements or they may be represented by pointers (or links) the elements themselves.

The terms “fabric” or “switched fabric” generally refers to a network topology where network nodes connect with each other via one or more network switches and abstracted by one or more layers of software including virtualization at the server level and a hierarchical grouping level.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The term “virtual machine” or “VM” generally refers to a self-contained operating environment that behaves as if it is a separate computer even though it is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

The methods and techniques described herein may be performed on a processor-based device. The processor-based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

Coupled to the network are a plurality of nodes 122. The nodes may be coupled to the Network through an access point 120 of directly using conventional means. The nodes may expose certain information (described herein) to users through one or more network connections. The nodes 122, like other connected devices (servers and data stores), may be characterized by unique identifiers such as MAC addresses, IP addresses, and the like. In some embodiments, the use of SSL web server certificate information may provide added security.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine-readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Microservices

Some embodiments may employ a microservice architecture, a software architectural style that structures an application as a collection of services that are easily maintainable, loosely coupled, independently deployable, and organized around business capabilities. The microservice architecture enables the rapid, frequent and reliable delivery of large, complex applications. It also enables an organization to evolve its technology stack.

### Node Chain

In some embodiments, the nodes 122 expose to the network information applicable to a transaction. The nodes may be a variety of network connected devices each with a unique identifier. To effectuate a transaction the node may expose to the network certain information. This exposed information may include one or more of:
Product or service descriptor
Quantity
Price
Location
Contract terms
Buy or sell price
Unique node information (IP address, MAC address, etc.)
Block chain information
Payment information
   In operation, collections of nodes may be grouped together to effectuate a node. A node chain is a collection of nodes grouped by one or more predetermined parameters. The node chain may be identified in a data store by one or more key words and pointers to the applicable nodes. In some embodiments the nodes may be coupled together serially so that a pointer only needs to point to a singe node and the node chain may be traversed using relative pointers imbedded in a node's exposed data. For example, and without limitation, a first node in the chain may include a pointer to a second node, etc.

Each node in the node chain may expose to the network commercial offering information such as a product or service information, terms or contract information, (which governs the conditions of a transaction), and payment information. In some embodiments each of these may be exposed on different channels or ports to provide for security and ease of processing. Certain nodes may also expose to the network associated nodes. For example, and without limitation, a node that provides for leasing an automobile, may expose node information for a related product such as an insurance provider.

The node chain operates as a single process in certain embodiments allowing the resource controlled by the node to operate to complete a transaction. In complex processing many diverse resources may be collected to form a node chain of those resources. Accordingly, operations which are currently limited to performance by a few entities may now be expanded to large numbers of devices all acting in accord. For example, and without limitation, transactions occurring on multiple exchanges (stocks, commodities, etc.) may be executed all at once by directing the node chain to complete various transactions using the technique disclosed herein.

In operation the node's communications may be implemented using multiple communication ports or URL addressing. For example, and without limitation, TCP/IP ports may be used for each facet of operation as described herein. Also, URL addressing may be effectuated by using a different URL address for interacting with a node. Internally, the node will receive ordering information, term information and payment information when a transaction is completed.

### Contract Chain

The nodes may contain contract information for the resource provided by the node. For example, and without limitation, the goods, process or service provided by the resource. The contract information may include the terms and conditions for using the node. For a simple sale the contract might simply state the product, quantity and price. For more complex transactions, the contract might stipulate terms such a delivery, FOB, availability and the like.

For some products the contract terms may reference mutually agreed-upon indicators such as a spot price for a commodity or a standard shipping rate (i.e. “free shipping”).

### Payment Chain

Payment may in in the form of an exchange of currency or, in some cases, of crypto currency such as Bitcoins, Ethereum and the like. In some embodiment's payment may be effectuated using a transitional crypto currency. Transitional currency maybe be currency created for use in processing the transaction and converted to another form of currency once the transaction is completed. A payment chain is a collection of nodes where payment information related to the transaction is effectuated. In operation, this may entail multiple payments using multiple nodes in a node chain. In some embodiments the payment will be processed in a different digital path (port or URL) than the service provided.

Transitional crypto currency may be used in some embodiments. This may entail converting, at a node, currency to and from the local (native) currency to a transitional currency. For example, and without limitation, for a node to cause a payment for a transaction, it would convert local currency to a transitional crypto currency and offer the crypto currency to other participants. For a node to receive payment, it would receive the transitional crypto currency information and convert it to local currency. Not every embodiment may require the crypto currency be converted to local currency, because the nature of future transactions may entail the use of crypto currency on hand.

Crypto currency information may be transferred by supplying key information similar to those operations performed in commercial exchanges.

### Server

The server 110 provides data and operations to regulate and, in some instances, effectuate proposed transactions. For example, and without limitation, the server 110 may create a virtual chain of devices such as a node chain which operate together to complete a transaction. The chain of nodes may be categorized and stored in a data store 112. The chain of nodes may include a unique identifier for each node as well as representative information for the product or service provided by each node. The server may operate with dedicated software engines for performing specific tasks. For example, a payment engine may be provided to control payment information while a separate engine may be employed to process transactions.

Each node in a node chain may include payment information creating a payment chain and transaction information creating a transaction chain. The server 110 may effectuate transactions by identifying nodes to create a node chains and their associated payment chains. Moreover, transactions from each node may then be compared to identify matches before execution of a transaction. The contracts are bound to the node in a manner that may obligate the node (networked resource) to perform under the contract provisions.

In operation the contract and the transaction may be implemented using multiple communication ports or URL addressing. For example, and without limitation, TCP/IP ports may be used for each facet of operation, say a port for the contract and a different port for a payment. URL addressing may be effectuated by using a different URL address for the contract and the payment.

### Demand Node

A demand node may be included to effectuate a demand for products or services offered by the node chains (the “market”). The demand (or buyer) node may include a user interface. The interface includes selection tools for selecting the marketplace from the service providers, describing the products or services desired, and communicating with the providers in the node chain. In differing embodiments, the demand node may include regulation controls which allow a user to set membership criteria for a market. In other embodiments, a server may have pre-defined members for a particular market.

When a buyer identifies a desired product or service in a node chain, a transaction may be completed if the terms are as stated by both the market member's resource terms and the buyer's terms. In some embodiments, the buyer may be given an opportunity to negotiate with a service provider using the communications channel. If the negotiations match terms then a transaction will occur.

### Transactions

FIG. 2 illustrates an embodiment that may be employed using the techniques described herein. In this embodiment a transaction may be completed by two or more nodes in response to the type and nature of the transaction. While the steps are presented in the order shown in FIG. 2, not every embodiment needs to follow this order and not every step needs to be performed in every embodiment.

The method of FIG. 2 begins at a flow label 200.

At a step 210 a server polls network connected resources to determine what resources are available, and at a step 212 information from the polling is stored in a data store such as XML, SQL, and the like.

At a step 214 information is received regarding a desired transaction. This information may be from a user or from an automated device. The desired transaction is not limited to resources provided by a single node but may include complex operations involving many nodes. For example, and without limitation, a care rental agreement may include car rental form one company but purchase if insurance form another company.

At a step 216 a node chain is created which includes possible resources which may be used to effectuate the transaction.

At a step 218 the contract information for each node is analyzed to ensure compliance with the requested transaction. Analysis may be performed in a variety of ways.

At a step 220 the transaction is exercised which may include finalizing contracts from multiple nodes. The nodes may be tied to a specific machine identifier such as a subnet and MAC or IP address, ensuring the parties who are obligated under the transaction.

At a step 222 currency units are transferred between nodes. This may involve recording the ownership of crypto currencies in response to the details of the transactions

At a step 224 the transaction records are recorded. In certain embodiments the transactions are immutably recorded such as those stored in a block chain.

At a flow label 226 the method ends.

The transaction may be financial, such as an offer for purchase, trade information, and the like. In complex operations the processing may involve transactions involving more than 1 node in the node chain.

The system may work with regards to financial services as well. For example, and without limitation, startup funding may be effectuated wherein several nodes in the node chains include venture capital information and other funding sources. These funding sources may also be connected to the venture capital service provider. An open market may be created for financing a business wherein each node provides their required contract terms and other predetermine information such as investment type or industry.

A demand node may provide business plan information including required funding, industry and related terms, which may be in the form of a term sheet. A server may identify the node chain that creates an open market and according to the techniques described herein effectuate an agreement for financing. Once agreement is reached between nodes, the transaction completes, and related payment information is processed.

### Recording Transactions

Regardless of the transaction type, once agreement is reached between nodes, the transaction completes, related payment information is processed and immutably stored in a data store. For security it is preferable that the transaction is executed as close to the payment operation as feasible. Separating the payment channel from the service channel may streamline this operation to a near real-time operation.

Recording the transaction may be performed in any reliable data store, however a blockchain-type storage process provides additional benefits. A blockchain is a growing list of records, called blocks, that are linked using cryptography. Each block contains a cryptographic hash of the previous block, a timestamp, and transaction data. Besides being inherently secure, the blockchain provides a wealth of information for future transaction. For example, and without limitation, certain embodiments may provide for mining a transaction blockchain to identify new markets for future node chains.

In a representative transaction, a user may desire to buy a certain product. The user would operate a demand node to identify the market best suited for purchasing the product. For example, a collection of local vendors for the product. If the desired price is proposed by a node, then a transaction may be completed. The user's local currency may be translated into a cryptocurrency. The seller of the product will accept the cryptocurrency for payment as well as the contract terms governing the sale. The entire transaction would then be immutably recorded into a blockchain. The seller would then convert the crypto currency into a currency of choice.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and, in a manner, consistent with the scope of the invention, as set forth in the following claims.

I claim:

1. A system including:
a resource chain said resource chain including a plurality of communicably coupled resource nodes, each resource node operable to communicate a product or a service information;
a payment chain, said payment chain including a plurality of communicably coupled payment nodes, each payment node operable to communicate financial information;
a demand node, said demand node including an interface operable to receive a transaction request, said transaction request including a product or service, and
a processing device coupled to the demand node, the resource chain, and the payment chain, said processing device including processor readable instructions directing the processor to perform a method including:
receiving a transaction request;
comparing the transaction request to the product or service information;
initiating a transaction in response to said comparing, and
transferring payment information from a first payment node to a second payment node.

2. The system of claim 1 wherein the resource chain includes product or service information grouped into unique markets.

3. The system of claim 1 wherein the payment chain includes nodes with different native currency units.

4. The system of claim 1 wherein the payment chain operates with a transitional currency.

5. The system of claim 1 wherein the first payment node and the second payment node operate with crypto currency.

6. The system of claim 1 wherein the service is a financial service.

7. The system of claim wherein the method further includes:
polling the resource nodes to determine what resources are available.

8. A method of commerce including:
receiving, at a network server, a marketplace information, said marketplace information indicative of a plurality of commercial resources, said marketplace information including a resource term;
receiving at the server a transaction request, said transaction request including a commercial request with at least one request term;
identifying at least one of the plurality of commercial resources with substantially similar resource term and request term;
initiating a transaction in response to said identifying, and
transferring payment information from a first payment node to a second payment node in response to conclude the transaction.

9. The system of claim 8 wherein the commercial resources includes product or service information grouped into unique markets.

10. The system of claim 8 wherein the first payment node and the second payment node have different native currency units.

11. The system of claim 8 wherein the payment information includes a transitional currency.

12. The system of claim 8 wherein the first payment node and the second payment node operate with crypto currency.

13. The system of claim 8 wherein the commercial resource is a financial service.
